(19) United States
(12) Patent Application Publication
(10) Pub. No.: US 2026/0132277 A1
(43) Pub. Date: May 14, 2026

(54) RUBBER COMPOSITIONS AND ARTICLES THEREOF

(71) Applicant: The Goodyear Tire & Rubber Company, Akron, OH (US)

(72) Inventors: Claude Schweitzer, Luxembourg (LU); Cyril Jean-Louis Bomble, Arville (BE); Fabien Ocampo, Thionville (FR); Sebastien Penin, Mertzig (LU); David Heinke, Brandenburg (DE)

(21) Appl. No.: 18/944,813

(22) Filed: Nov. 12, 2024

(51) Int. Cl. C08L 9/06; B60C 1/00; C08F 8/42; C08K 3/36; C08K 9/06

(52) U.S. Cl. CPC C08L 9/06; B60C 1/0016; B60C 1/0025; C08F 8/42; C08K 3/36; C08K 9/06; C08L 2312/02; C08L 2312/08

(57) ABSTRACT

Uncured rubber compositions, methods of making uncured rubber compositions, vulcanized rubber compositions, methods of making vulcanized rubber composition, and articles (e.g., tires, components of tires) including the vulcanized rubber composition are provided. The materials provided herein can be used in articles such as tires to reduce the maximal lateral force, which can improve roll-over-performance and wet braking performance, while maintaining or improving snow performance.

### BACKGROUND

The demand for improved tire performance in trucks and SUVs has resulted in the development and evaluation of new materials that have desired properties such as lower maximal lateral force and improved wet braking performance. In tire elastomer compositions, improving maximal lateral force usually comes at the cost of reducing the stiffness of the composition and/or the glass transition temperature of the composition, but this can lead to poor wet braking performance. Improving properties such as maximal lateral force while maintaining or improving wet braking performance can be challenging. There is a need for elastomer compositions for tires that can provide lower maximal lateral force, while at the same time maintaining desired properties of the material such as wet braking performance.

### SUMMARY

In accordance with the purpose(s) of the present disclosure provides for uncured rubber compositions, methods of making uncured rubber compositions, vulcanized rubber compositions, methods of making vulcanized rubber composition, articles (e.g., tires, components of tires) including the vulcanized rubber composition, and the like.

In an aspect, the present disclosure provides for an uncured rubber composition comprising: about 20 to 100 phr of a styrene butadiene elastomer; a resin, an oil, or the resin and oil, wherein the total of the resin, the oil, or the resin and oil is about 50 to 80 phr; and about 100 to 150 phr of a chemically treated silica, wherein a ratio of the chemically treated silica and resin, oil, or resin and oil is greater than 0.50.

In an aspect, the present disclosure provides for a vulcanized rubber composition comprising the uncured rubber composition as described above and herein. In an aspect, the article comprises the vulcanized rubber composition as described above and herein. The article can be a tire or a component of a tire.

Other composition, methods, features, and advantages of the present disclosure will be or become apparent to one with skill in the art upon examination of the detailed description. It is intended that all such additional compositions, methods, features, and advantages be included within this description, be within the scope of the present disclosure, and be protected by the accompanying claims. In addition, all optional and preferred features and modifications of the described embodiments are usable in all aspects of the disclosure taught herein.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Prior to describing the various aspects of the present disclosure, the following definitions are provided and should be used unless otherwise indicated. Additional terms may be defined elsewhere in the present disclosure.

### Definitions

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, the term “phr” refers to parts by weight of a respective material per 100 parts by weight of rubber or elastomer. In general, using this convention, an elastomer composition is comprised of 100 parts by weight of rubber/elastomer. The claimed composition may comprise other rubbers/elastomers than explicitly mentioned in the claims, provided that the phr value of the claimed rubbers elastomers is in accordance with claimed phr ranges and the amount of all rubbers/elastomers in the composition results in total in 100 parts of rubber.

The terms “rubber” and “elastomer” may be used herein interchangeably, unless indicated otherwise.

As used herein, the “glass transition temperature” or “T_{g}”, of an elastomer or rubber represents the glass transition temperature(s) of the respective elastomer or rubber in its uncured state or, in the case of an elastomer composition, in some aspects, T_{g} can be measured in a cured state. In an aspect, T_{g} can be suitably determined as a peak midpoint by a differential scanning calorimeter (DSC) using a test standard such as, for example, ASTM D7426 or equivalent.

As used herein, the term “uncured composition” refers to a composition including at least one natural or synthetic rubber component and, optionally, one or more fillers, processing aids, or additional compounds, that has not been vulcanized. Uncured rubber is sensitive to changes in temperature and has a tendency to undergo “cold flow” (slow movement or deformation under stress) over time. In some aspects, the uncured rubber composition is a masterbatch.

As used herein, the term “vulcanized rubber composition” refers to a rubber composition obtained by taking an uncured composition as described herein and curing or vulcanizing it, often accomplished using sulfur compounds and/or other curing additives and in the presence of heat. Vulcanized or cured rubber does not undergo cold flow and is less sensitive to changes in temperature relative to uncured rubber. In another aspect, rubber compositions can be cured in molds in order to form finished articles including, but not limited to, tires.

Unless otherwise specified, pressures referred to herein are based on atmospheric pressure (i.e. one atmosphere).

### Discussion

The present disclosure provides for uncured rubber compositions, methods of making uncured rubber compositions, vulcanized rubber compositions, methods of making vulcanized rubber composition, articles (e.g., tires, components of tires) including the vulcanized rubber composition, and the like. The present disclosure provides for materials that can be used in articles such as tires to reduce the maximal lateral force, which can improve roll-over-performance and wet braking performance, while maintaining or improving snow performance.

The present disclosure provides for uncured rubber compositions. In an aspect, the uncured composition can include a low T_{g} styrene butadiene elastomer; an oil, a resin, or both the oil and resin; and a chemically treated silica. In addition, the uncured composition has a glass transition temperature (T_{g}) of about −50 to −30° C. In an aspect, the uncured composition includes about 20 to 100 phr, about 50 to 100 phr or about 50 to 80 phr of the styrene butadiene elastomer. In an aspect, the uncured composition includes about 100 to 150 phr or about 110 to 120 phr of the chemically treated silica. In an aspect, the uncured composition includes about 50 to 80 phr or about 60 to 70 phr of the resin, the oil, or the resin and oil (e.g., the sum of the resin and oil is about 50 to 80 phr or about 60 to 70 phr). In an aspect, the uncured composition includes about 37 to 47 phr of the resin and about 17.5 to 27.5 phr of the oil. In an aspect, the ratio of the chemically treated silica and resin, oil, or resin and oil in the uncured rubber composition is greater than 0.5 (e.g., 0.5 to 0.8), greater than 0.55 (e.g., 0.55 to 0.6), or greater than 0.60 (e.g., 0.6 to 0.8). Example 1 illustrates additional formulations of the uncured composition.

In an aspect, the low T_{g} styrene butadiene elastomer can be functionalized with at least one functional group such as a sulfur containing functional group. Suitable sulfur containing groups include a mercapto group (e.g., mercaptosilane), a thiol group, a thioether group, a thioester group, a sulfide group, or a sulfanyl group. The styrene butadiene elastomer can be functionalized at the polymer chain ends for example via functional initiators or terminators, or within the polymer chains for example via functional monomers, or a combination of in-chain and end-of-chain functionalization.

In an embodiment, the styrene butadiene elastomer can be prepared by organic solution prepared polymerization of styrene and 1,3-butadiene monomers having a styrene content of 15 percent and a 1, 2-vinyl content of 26 percent (based on the polybutadiene portion of the SBR) as Sprintan SLR 3402™ from Trinseo. In an aspect, the SBR can be functionalized with a mercapto group (e.g., mercaptosilane).

In an embodiment, the resin can be a petroleum hydrocarbon resin. Such petroleum hydrocarbon resin may be, for example, an aromatic and/or nonaromatic (e.g. paraffinic) based resin. Various petroleum resins are available. Some petroleum hydrocarbon resins have a low degree of unsaturation and high aromatic content, whereas some are highly unsaturated and yet some contain no aromatic structure at all. Differences in the resins are largely due to the olefins contained in the petroleum-based feedstock from which the resins are derived. Conventional olefins for such resins include any C5 olefins (olefins and diolefines containing an average of five carbon atoms) such as, for example, cyclopentadiene, dicyclopentadiene, isoprene and piperylene, and any C9 olefins (olefins and diolefins containing an average of 9 carbon atoms) such as, for example, vinyltoluene and alphamethylstyrene. Such resins may be made from mixtures of such C5 and C9 olefins. In another aspect, the resin can be a terpene resin such as limonene, alpha pinene and beta pinene.

In an embodiment, the oil may include a low PCA oil such as mild extraction solvates (MES), treated distillate aromatic extracts (TDAE), residual aromatic extract (RAE), SRAE, heavy napthenic oils, and vegetable oils (e.g., sunflower, soybean, rapeseed, and safflower oils).

In one aspect, the silica can be a chemically treated silica, such as a pre-silanized silica, and can comprise an alkylsilane, an alkoxysilane, an organoalkoxysilyl polysulfide, or an organomercaptoalkoxysilane bonded to the silica. In another aspect, the chemically treated silica can include a silica with a sulfur-containing silane bonded to the silica. In one aspect, the sulfur-containing silane can include an alkoxyorganomercaptosilane or a bis(3-triethoxysilylpropyl) polysulfide, with an average of about 2 to 5 connecting sulfur atoms in its polysulfidic bridge. Examples of chemically treated silicas suitable for use in the compositions described herein include Ciptane® 255 LD and Ciptane® LP (PPG Industries); silicas that have been pre-treated with a mercaptosilane; Coupsil® 8113 (Degussa); Coupsil® 6508; and Agilon® 400, 454, and 458 silica from PPG Industries.

In one aspect, the chemically treated silica can be treated with a silica dispersing aid. Such silica dispersing aids may include glycols, such as fatty acids, diethylene glycols, polyethylene glycols, fatty acid esters of hydrogenated or non-hydrogenated C5 or C6 sugars, and polyoxyethylene derivatives of fatty acid esters of hydrogenated or non-hydrogenated C5 or C6 sugars. Exemplary fatty acids include stearic acid, palmitic acid and oleic acid. Exemplary fatty acid esters of hydrogenated and non-hydrogenated C5 and C6 sugars (e.g., sorbose, mannose, and arabinose) include, but are not limited to, the sorbitan oleates (such as sorbitan monooleate, dioleate, trioleate, and sesquioleate) as well as sorbitan esters of laurate, palmitate, and stearate fatty acids. Exemplary polyoxyethylene derivatives of fatty acid esters of hydrogenated and non-hydrogenated C5 and C6 sugars include, but are not limited to, polysorbates and polyoxyethylene sorbitan esters, which are analogous to the fatty acid esters of hydrogenated and non-hydrogenated sugars noted above except that ethylene oxide groups are placed on each of the hydroxyl groups.

In an aspect, the uncured rubber compositions and vulcanized rubber compositions can comprise additional components, such as zinc oxide, fatty acids, anti-degradants activators, retarders, pigments, fatty acids, waxes, antioxidants, antiozonants, peptizing agents, and the like.

Also disclosed herein are vulcanized rubber compositions including the uncured compositions described herein that have been vulcanized and articles including tires and/or components of tires (e.g., part of the tread, base, sidewall) made from or including the vulcanized rubber compositions. The vulcanized or cured compositions have improved roll-over-performance and wet braking performance relative to similar tires that have different low T_{g} SBR, the amount of treated silica, the oil, and the C9 resin.

The uncured rubber composition can further include about 0.4 phr to about 15.0 phr of a vulcanizing agent, or about 0.4 phr, 3.0 phr, 6.0 phr, 9.0 phr, 12.0 phr, or 15.0 phr, where any value can be a lower and upper endpoint of a range (e.g., 9.0 phr to 12.0 phr). In some aspects, the vulcanizing agent includes elemental sulfur, a sulfur-containing silane, or a combination thereof. Additionally, the uncured rubber composition can further include a vulcanizing accelerator. Vulcanizing accelerators can be preferably but not necessarily used to control the time and/or temperature required for vulcanization and to improve the properties of a vulcanized composition. The amount of vulcanizing accelerator in the composition can be in the amount of about 0.3 phr to about 4.0 phr, or 0.3 phr, 1.0 phr, 2.0 phr, 3.0 phr, or 4.0 phr, where any value can be a lower and upper endpoint of a range (e.g., 1.0 phr to 2.0 phr).

In an aspect, the vulcanizing accelerator includes a dithiocarbamate accelerator, a thiuram accelerator, a diphenylguanidine accelerator, a benzothiazole sulfenamide accelerator, or a combination thereof. The potential vulcanizing accelerator compounds can include derivatives, e.g., a benzothiazole sulfenamide accelerator includes benzothiazole sulfenamide and can also include derivatives of benzothiazole sulfenamide. In other aspects, the vulcanizing accelerator includes amines, disulfides, guanidines, thioureas, thiazoles, thiurams, sulfenamides, dithiocarbamates and xanthates. In another aspect, the vulcanizing accelerator includes combinations of a primary and a secondary accelerator, where the secondary accelerator is used in smaller amounts, such as from 0.05 phr to 3.00 phr. In an aspect, the secondary accelerator is selected from a guanidine, a dithiocarbamate, or a thiuram. In addition, delayed action accelerators can be used which are not affected by normal processing temperatures but produce a satisfactory cure at ordinary vulcanization temperatures.

The uncured rubber compositions and vulcanized rubber compositions disclosed herein can be compounded by methods generally known in the rubber compounding art, such as mixing the components described herein with various commonly used additive materials such as sulfur donors; curing aids, such as activators and retarders; pigments; fatty acids; zinc oxide; waxes; antioxidants; antiozonants; and peptizing agents. Depending on the intended use of the vulcanizable and vulcanized material (rubbers), the additives mentioned above are selected and commonly used in conventional amounts. Representative antioxidants include, but are not limited to, diphenyl-p-phenylenediamine and others, such as those disclosed in The Vanderbilt Rubber Handbook (1978), Pages 344 through 346. In some aspects, antiozonants are included in amounts of about 1 phr to 5 phr. Representative antiozonants include, but are not limited to, N-phenyl-N′-(1,3-dimethylbutyl)-p-phenylenediamine (6PPD) and N,N′-dixylene-p-phenylenediamine (DTPD). Examples of fatty acids used includes stearic acid. Microcrystalline waxes can be used. Typical peptizers include, for example, pentachlorothiophenol and dibenzamidodiphenyl disulfide.

Vulcanization of the disclosed tires is generally carried out at conventional temperatures ranging from about 100° C. to about 200° C. or from about 110° C. to about 180° C.

The compositions disclosed herein can be mixed by methods known in the rubber mixing art. For example, the ingredients may be typically mixed in at least two stages, namely, at least one nonproductive stage followed by a productive mix stage. In an aspect, the mixing of the uncured composition comprises only a single nonproductive stage. The final curatives including vulcanizing agents may be typically mixed in the final stage which is conventionally called the “productive” mix stage in which the mixing typically occurs at a temperature, or ultimate temperature, lower than the mix temperature(s) of the preceding nonproductive mix stage(s). In an embodiment, the elastomer composition may be subjected to a thermomechanical mixing step. The thermomechanical mixing step generally comprises a mechanical working in a mixer or extruder for a period of time, for example suitable to produce a rubber temperature which is within the range of about 140° C. to 190° C. The appropriate duration of the thermomechanical working varies as a function of the operating conditions, and the volume and nature of the components. For example, the thermomechanical working may be from about 1 to 20 minutes.

This disclosure also provides for articles that incorporate any of the vulcanized rubber compositions disclosed herein. In an aspect, the article comprises a tire, such as a pneumatic tire, or a component of a tire. The tire can be a race tire, passenger tire, aircraft tire, agricultural, earthmover, off-the-road, truck tire, or the like. In one aspect, the tire is a passenger or truck tire. The tire can also be a radial or bias. The component of the tire can be a tread, base, sidewall, apex, chafer, sidewall insert, wirecoat, innerliner, or any combination thereof. In another aspect, the component of the tire including the composition is a tread, base, sidewall, or any combination thereof. Such tires can be built, shaped, molded and cured by various methods which are known and will be readily apparent to those having skill in such art. In an aspect, the component of the tire is part of the tread as opposed to the entire tread.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered Aspects, which should not be confused with the claims.

Aspect 1. An uncured rubber composition comprising: about 20 to 100 phr of a styrene butadiene elastomer; a resin, an oil, or the resin and oil, wherein the total of the resin, the oil, or the resin and oil is about 50 to 80 phr; and about 100 to 150 phr of a chemically treated silica, wherein a ratio of the chemically treated silica and resin, oil, or resin and oil is greater than 0.50.

Aspect 2. The composition of each of the aspects, wherein the amount of the styrene butadiene elastomer is about 50 to 80 phr, wherein the amount of the resin, the oil, or the resin and oil is 60 to 70 phr; and wherein the chemically treated silica is about 110 to 120 phr.

Aspect 3. The composition of each of the aspects, wherein the resin is about 37 to 47 phr and the oil is about 17.5 to 27.5.

Aspect 4. The composition of each of the aspects, wherein the oil is a treated distillate aromatic extract.

Aspect 5. The composition of each of the aspects, wherein the resin is a C9 olefin.

Aspect 6. The composition of each of the aspects, wherein the C9 olefin is hydrogenated dicyclopentadiene.

Aspect 7. The composition of each of the aspects, wherein the styrene butadiene elastomer is a 15% styrene, 26% vinyl; Sn-coupled; mercaptosilane end functionalized styrene butadiene elastomer.

Aspect 8. The composition of each of the aspects, wherein the chemically treated silica is selected from the group consisting of: an alkylsilane, an alkoxysilane, an organoalkoxysilyl polysulfide, and an organomercaptoalkoxysilane bonded to the silica.

Aspect 9. The composition of each of the aspects, wherein the chemically treated silica is a silica with a sulfur-containing silane bonded to the silica.

Aspect 10. The composition of each of the aspects, wherein the uncured composition has a glass transition temperature (T_{g}) of about-50 to −30° C.

Aspect 11. A vulcanized rubber composition comprising the uncured rubber composition of each of the aspects that has been vulcanized.

Aspect 12. An article comprising the vulcanized rubber composition of each of the aspects.

Aspect 13. The article of each of the aspects, wherein the article comprises a tire or a component of a tire.

Aspect 14. The article of each of the aspects, wherein the component of the tire comprises a tread, base, sidewall, or any combination thereof.

### EXAMPLES

The following examples are put forth so as to provide those of ordinary skill in the art with a complete disclosure and description of how the compounds, compositions, articles, devices and/or methods claimed herein are made and evaluated. These examples are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Rubber Compositions

Three elastomer compositions and a control elastomer composition are shown in Table 1. Most of the ingredients of the three compositions are the same (e.g., but different amounts in some instances), while the control composition include many of the same ingredients with some notable differences. For example, the differences between the control and the three compositions are in use of a low Tg SBR, the amount of treated silica, the oil, and the C9 resin. Also seen in Table 1, the properties of the control composition and the three elastomer compositions are similar or improved.

| | Control | Example | Example | Example |
|---|---|---|---|---|
| Description | (phr) | 1 (phr) | 2 (phr) | 3 (phr) |
| Styrene butadiene elastomer (15% styrene, | | 55 | 68 | 80 |
| 26% vinyl; Sn-coupled; mercaptosilane end | | | | |
| functionalized) (SPRINTAN ™ SLR 3402) | | | | |
| Styrene butadiene elastomer (27% styrene; | 30 | | | |
| 42% vinyl; Si-coupled; aminosilane end | | | | |
| functionalized) (HPR355H) | | | | |
| Polybutadiene (BUDENE ® 1229) | 30 | 45 | 32 | 20 |
| Natural rubber | 40 | | | |
| Chemically treated silica (AGILON ® 400 | 70 | 115 | 115 | 115 |
| GD) | | | | |
| Carbon black | 1 | | | |
| TDAE oil (VIVATEC ™ 400) | | 22.5 | 22.5 | 22.5 |
| Naphthenic oil | 1 | | | |
| HDCPD/C9 resin (OPPERA ™ PR383) | | 42 | 42 | 42 |
| Styrene/alpha-methystyrene resin | 16 | | | |
| White gum rosin | | 3 | 3 | 3 |
| Wax | 1.5 | 1.5 | 1.5 | 1.5 |
| Processing aid | 3 | | | |
| N-(1,3 dimethyl butyl)-N′-phenyl-p- | 2.5 | 2.5 | 2.5 | 2.5 |
| phenylene diamine | | | | |
| Stearic Acid | 2 | 2 | 2 | 2 |
| Bis [3-(triethoxysilyl) propyl] tetrasulfide on | | 2 | 2 | 2 |
| carbon black carrier (50%) | | | | |
| Mixed aryl-p-phenylenediamines | 0.75 | 0.5 | 0.5 | 0.5 |
| Zinc oxide | 3 | 2.5 | 2.5 | 2.5 |
| Sulfur | 2.15 | 1.2 | 1.2 | 1.2 |
| N-cyclohexyl benzothiazol-2-sulfenamide | 1.3 | 2.55 | 2.55 | 2.55 |
| Diphenylguanidine | 0.3 | 1.7 | 1.7 | 1.7 |
| Wet braking rating | 100 | 110 | 117 | 122 |
| Wet grip index | 1.22 | | 1.3 | 1.35 |
| Lateral force (6° slip angle) [N] | 8384 | 8156 | 8065 | 8124 |
| Rolling resistance [N/kN] | 6.2 | 6.39 | 6.16 | 6.49 |
| Storage modulus at low temperatures | | | | |
| (E′ at −30° C. and −40° C.) | | | | |
| E′ −30° C. [MPa] | 43.2 | 26.2 | 36.4 | 45.4 |
| E′ −40° C. [MPa] | 113.6 | 66.2 | 113.9 | 195.2 |

In regard to Table 1, the complete tread of the tire is made of the composition as opposed to only part of the tread.

As shown above, the tires of Examples 1-3 show a lower lateral force value compared with the Control Sample. Such low lateral force values are desirable for vehicles with a relatively high center of gravity such as for SUVs, as a limited lateral force supports avoidance of rollovers. In particular, such a tire will start to slide at a certain maximum slip angle instead of building up an even high lateral force under increasing slip angle which could under extreme cornering maneuvers provoke a rollover condition.

At the same time, the tires of Example 1-3 exhibit an improved wet braking performance and wet grip index. This is consistent with the higher silica level in Examples 1-3 compared with the Control Sample. Such an increase of silica level is expected to cause a significant increase of rolling resistance, leading to the typical wet braking/rolling resistance trade-off in tires. Surprisingly, this is not observed in this case. Examples 1 and 3 only show a small increase, and Example 2 even shows a reduction of rolling resistance. This behavior is attributed to the combination of chemically treaded silica with an unusually high plasticizer/filler ratio of 0.56, to be compared with a ratio of 0.26 for the Control Sample, which contains the same chemically treated silica.

Table 1 also shows the storage modulus of the compounds at low temperatures. A reduced storage modulus in this temperature range is indicative of an improved snow braking performance. Thus, the data indicate that Examples 1 and 2 have better snow performance than control. The simultaneous improvement of wet and snow performance is attributed to the high filler level, combined with a high plasticizer/filler ratio.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. An uncured rubber composition comprising:
about 20 to 100 phr of a styrene butadiene elastomer;
a resin, an oil, or the resin and oil, wherein the total of the resin, the oil, or the resin and oil is about 50 to 80 phr; and
about 100 to 150 phr of a chemically treated silica,
wherein a ratio of the chemically treated silica and resin, oil, or resin and oil is greater than 0.50.

2. The composition of claim 1, wherein the amount of the styrene butadiene elastomer is about 50 to 80 phr, wherein the amount of the resin, the oil, or the resin and oil is 60 to 70 phr;
and wherein the chemically treated silica is about 110 to 120 phr.

3. The composition of claim 1, wherein the resin is about 37 to 47 phr and the oil is about 17.5 to 27.5.

4. The composition of claim 1, wherein the oil is a treated distillate aromatic extract.

5. The composition of claim 1, wherein the resin is a C9 olefin.

6. The composition of claim 5, wherein the C9 olefin is hydrogenated dicyclopentadiene.

7. The composition of claim 1, wherein the styrene butadiene elastomer is a 15% styrene, 26% vinyl; Sn-coupled; mercaptosilane end functionalized styrene butadiene elastomer.

8. The composition of claim 1, wherein the chemically treated silica is selected from the group consisting of: an alkylsilane, an alkoxysilane, an organoalkoxysilyl polysulfide, and an organomercaptoalkoxysilane bonded to the silica.

9. The composition of claim 1, wherein the chemically treated silica is a silica with a sulfur-containing silane bonded to the silica.

10. The composition of claim 1, wherein the uncured composition has a glass transition temperature (T_{g}) of about −50 to −30° C.

11. A vulcanized rubber composition comprising the uncured rubber composition of claim 1 that has been vulcanized.

12. An article comprising the vulcanized rubber composition of claim 11.

13. The article of claim 12, wherein the article comprises a tire or a component of a tire.

14. The article of claim 13, wherein the component of the tire comprises a tread, base, sidewall, or any combination thereof.
